(19) United States
(12) Patent Application Publication
(10) Pub. No.: US 2018/0241811 A1
(43) Pub. Date: Aug. 23, 2018

(54) IDENTIFICATION OF INCOMPATIBLE CO-TENANT PAIRS IN CLOUD COMPUTING

(71) Applicant: Intel Corporation, Santa Clara, CA (US)

(72) Inventors: Li Chen, Hillsboro, OR (US); Krishnaswamy Viswanathan, Portland, OR (US); Khun Ban, Hillsboro, OR (US)

(73) Assignee: Intel Corporation, Santa Clara, CA (US)

(21) Appl. No.: 15/439,668

(22) Filed: Feb. 22, 2017

(51) Int. Cl. H04L 29/08

(52) U.S. Cl. CPC H04L 67/1012; H04L 67/1008

(57) ABSTRACT

Disclosed is a mechanism for determining incompatible co-tenants in a cloud network. Cloud performance data is received indicating resource usage of tenants operating on a per server basis. Cross-correlation analysis is performed on past resource usage for each tenant pair operating on the server to determine correlated tenant pairs. Time series forecasting of predicted resource usage is performed for each tenant in the correlated tenant pairs. Cross-correlation analysis is then performed on the predicted resource usage for each correlated tenant pair to determine incompatible co-tenant pairs. The determined incompatible co-tenant pairs may be forwarded toward an orchestration system for hardware resource allocation in the cloud network.

### BACKGROUND

Cloud computing technology supports on-demand elastic provisioning of resources for data center tenants. Software applications operate in whole or in part on individual servers in the cloud network. Hence, the software applications consume resources on the server where they are hosted. Such applications, or portions of applications, may be dynamically moved between physical servers at run time in an attempt to match resources to application resource demands, which results in a highly complex system that is difficult to predict and optimize. One optimization problem is the noisy neighbor problem. Resource usage of applications in a cloud network may be dynamic and may change continuously. When resource usage for multiple software applications on the same server spike at the same time, a processing slowdown may occur for all software applications on the server due to momentarily inadequate resources. This simultaneous demand may be referred to as the noisy neighbor problem. The noisy neighbor problem is made more difficult to address because an arbitrarily large number of software applications may be hosted simultaneously in the cloud network.

### BRIEF DESCRIPTION OF THE DRAWINGS

The concepts described herein are illustrated by way of example and not by way of limitation in the accompanying figures. For simplicity and clarity of illustration, elements illustrated in the figures are not drawn to scale unless otherwise noted.

FIG. 1 is a schematic diagram of an example of a cloud network.

FIG. 2 is a schematic diagram of an example architecture for identifying noisy neighbor tenants.

FIG. 3 is a schematic diagram of an example mechanism for identifying noisy neighbor tenants from groups of compatible tenants.

FIG. 4 is a flowchart of an example method for determining neighbor tenants in a cloud network.

FIG. 5 is a schematic diagram of an example network element for use in a cloud network.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, such feature, structure, or characteristic can be employed in connection with another disclosed embodiment whether or not such feature is explicitly described in conjunction with such other disclosed embodiment.

The disclosed embodiments may be implemented, in some cases, in hardware, firmware, software, or any combination thereof. The disclosed embodiments may also be implemented as instructions (e.g. a computer program product) carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

A noisy neighbor may describe a cloud computing infrastructure co-tenant that substantially monopolizes communication bandwidth, disk Input/Output (I/O) resources, Central Processing Unit (CPU) time, and other network resources, which can negatively affect other tenants cloud performance. The noisy neighbor effect may cause other tenants and applications that share the cloud infrastructure to suffer from uneven cloud network performance. Tenants may employ varying amounts of network resources at different times. Co-tenants that repeatedly make heavy use of similar resources at the same time can be described as having correlated resource usage. Such correlated tenant pairs can be considered incompatible and should be separated and hosted by different physical servers to increase network performance.

Disclosed herein are technical mechanisms/solutions to identify and address noisy neighbor tenants in a cloud computing network. Cloud performance data is received by a noisy neighbor conflict resolution system. The cloud performance data indicates resource usage of tenants operating on each server on a server by server basis. For each server, cross-correlation analysis is performed on each pair of tenants. Cross-correlation analysis includes comparing past resource usage for each tenant pair. If the cross-correlation exceeds a threshold, the pair of tenants are flagged as a correlated tenant pair. Time series forecasting is employed on each correlated tenant pair, for example by employing auto-regression modeling, to determine predicted future resource usage. Cross-correlation analysis may then be performed again on the predicted future resource usage, which may be referred to as second layer cross-correlation analysis. Correlated tenant pairs with predicted future correlation above a threshold may be considered incompatible co-tenant pairs (e.g. noisy neighbors). Such information may be forwarded to an orchestration system to allow the noisy neighbors to be separated to different physical servers (e.g. or different server clusters, etc.) to reduce correlated resource usage and increase overall cloud network performance.

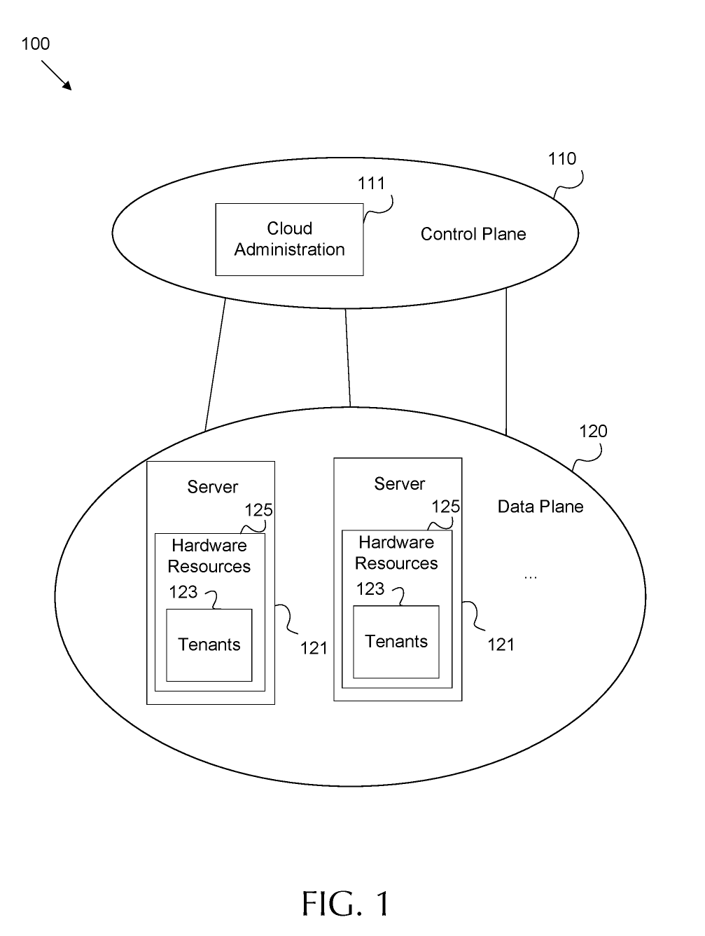

FIG. 1 is a schematic diagram of an example of a cloud network 100, which may be hosted in a data center, incorporated with the noisy neighbor avoidance technology of the present disclosure. The cloud network 100 may employ a control plane 110 and a data plane 120. The control plane 110 is the portion of the cloud network 100 designed to manage physical network topology, packet/frame routing, signaling, physical resource allocations, and other control functions. The data plane 120 is the portion of the cloud network 100 designed to perform computational tasks, store data, and communicate data based on instructions from the control plane 110. It should be noted that some physical hardware may operate on both the control plane 110 and the data plane 120 in some embodiments. For example, a single hardware component may include both control plane 110 processes and data plane 120 processes. As such, the distinction between the control plane 110 and the data plane 120 may be a functional distinction instead of a hardware distinction.

The data plane 120 may contain a plurality of servers 121. A server 121 is any computational device capable of providing services to clients. A server 121 contains hardware resources 125 to provide such services. Such hardware resources may be dedicated or shared. Hardware resources may include Central Processing Units (CPUs), random access memory (RAM), cache, network communication components, long term memory such as read only memory (ROM), and/or any other hardware components desired to operate software. In a cloud network 100, tenants 123 may operate on the hardware resources 125. A tenant 123 is any process (e.g. software application) that performs computing and/or communication tasks for a client. For example, a tenant 123 may include operating environments, such as virtual machines (VMs) and/or containers, as well as other software applications. It should be noted that the data plane 120 may contain additional components, such as shared memory devices, routers, switches, gateways, firewalls, and other networking resources.

The control plane 110 includes a cloud administration system 111. The cloud administration system 111 is any component or set of components for managing the configuration and/or operation of the data plane 120. For example, the cloud administration system 111 may be configured to measure and/or receive operational statistics of the servers 121, such as usage of hardware resources 125, (e.g. processor usage, memory usage, network resource usage, power usage, temperature, etc.), projected hardware resource 125 usage, derived statistics, etc. The cloud administration system 111 may then alter the elements of network 100 to support optimization based on the operational statistics. For example, the cloud administration system 111 may perform elastic provisioning by dynamically moving tenants 123 between servers 121 to temporarily allow active tenants 123 to obtain access to unused hardware resources, to temporarily reduce the hardware resource 125 allocation to less active tenants 123, etc. The cloud administration system 111 may be implemented in whole or in part on a processor/computing circuitry, in memory, in communications devices, or combinations thereof.

As discussed in greater detail below, the cloud administration system 111 is also designed to manage the noisy neighbor problem by determining tenants 123 that are incompatible and separating them onto different servers 121 or server clusters. For example, if two tenants 123 operating on the same server 121 are both programmed to employ a large amount of communication bandwidth at the same time (e.g. a burst of emails sent daily at 8:00 am), then the performance of both tenants 123 are degraded at that time as the network communication components are overloaded. Such a scenario may also affect other unrelated tenants 123 on the same server 121 when such tenants attempt to send communications of their own, as the network communication components are already being monopolized by the two noisy neighbors. Such a scenario is equally applicable to correlated usage of any other hardware resources 125. The cloud administration system 111 is designed to determine when hardware resource 125 usage of tenants 123 is correlated. Tenants 123 with correlated hardware resource 125 usage above a threshold may then be separated by hosting the correlated tenants 123 on different servers 121 to increase overall network 100 operational speed.

It should be noted that cloud network 100 is depicted as a greatly simplified diagram for purposes of discussion of the embodiments disclosed herein. One of skill in the art will recognize that cloud network 100 contains many additional components that are not directly relevant to the embodiments discussed herein. Such components may still be desirable for proper operation of cloud network 100 (e.g. routers, server racks, communication cables, access gateways, firewalls, etc.). The disclosure should be interpreted as including all such components and/or features as desired to support the operation of the embodiments disclosed herein.

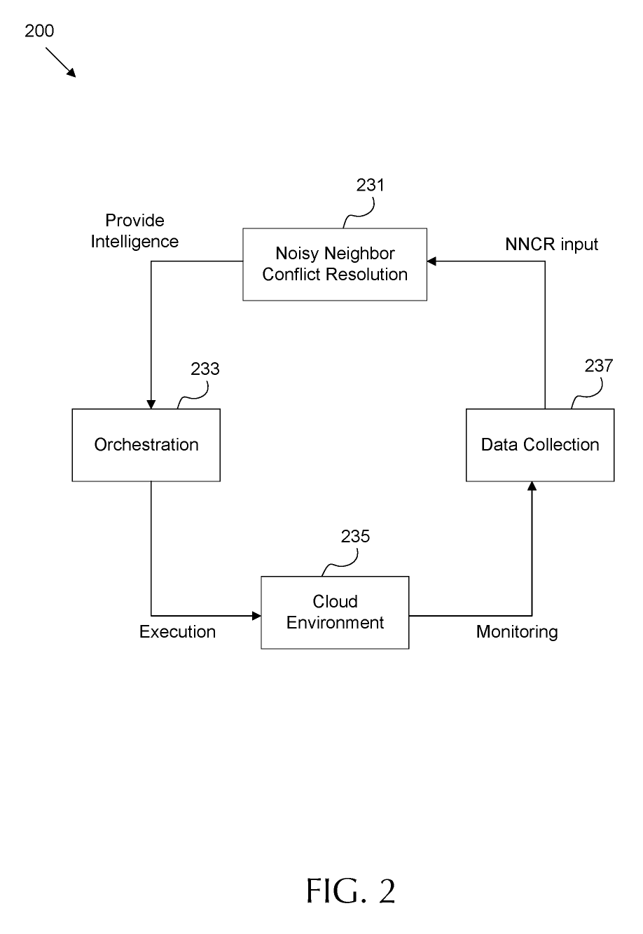

FIG. 2 is a schematic diagram of an example architecture 200 for identifying noisy neighbor tenants. Architecture 200 includes a cloud environment 235, a data collection system 237, a noisy neighbor conflict resolution system (NNCR) 231, and an orchestration system 233. The cloud environment 235 includes the operational state of a data plane, such as data plane 120, at a specified point in time. Accordingly, the cloud environment 235 includes servers with hardware resources employed by a configuration of tenants, such as servers 121, hardware resources 125, and tenants 123, respectively. The operation of the cloud environment is constantly monitored by a data collection system 237. The data collection system 237 may be implemented in a cloud administration system, such as cloud administration system 111, or by a dedicated monitoring system coupled to a cloud administration system. The data collection system 237 may collect/monitor cloud performance data at the hardware platform and/or at the operating system level. Such cloud performance data may be multi-dimensional and may indicate the hardware resource usage (e.g. cache usage, CPU usage, RAM usage, ROM usage, network bandwidth usage, shared memory usage, etc.) of the tenants operating on the servers in the cloud environment 235. As an example, Intel ® Resource Director Technology (RDT) may be leveraged to monitor shared resource usage, such as last level cache, memory bandwidth data, etc.

The NNCR 231 is a system designed to support optimization of the cloud environment 235 by determining noisy, malicious, or otherwise incompatible neighbor tenants so that such tenants can be separated to increase overall cloud environment 235 operation speed. The NNCR 231 may operate in a cloud administration system in a control plane, such as cloud administration system 111 and control plane 110, respectively. The NNCR 231 is designed to employ machine learning and predictive modeling to determine such incompatible co-tenants to support workload placement intelligence. For example, the NNCR 231 receives the cloud performance data from the data collection system 237. The NNCR 231 may then review the cloud performance data on a server by server basis. In other words, the NNCR 231 may iteratively consider the compatibility of the co-tenants operating on each server (e.g. one server at a time) to support moving any incompatible tenants to speed the overall network. In such a use case, the NNCR 231 may not need to review the compatibility of every tenant in the cloud network to every other tenant on the cloud network, and may only review co-tenants on a common server. For each server, the NNCR 231 employs screening, prediction, and validation to determine incompatible co-tenant pairs (e.g. noisy neighbors). Screening includes performing cross-correlation analysis on past resource usage, as received from the data collection system 237, for each tenant pair operating on the server to determine correlated tenant pairs. Any tenant pair on a server with a positive or negative cross-correlation in excess of a threshold (τ) may be flagged as a correlated tenant pair.

The NNCR 231 then performs prediction for all flagged tenant pairs. Prediction includes performing time series forecasting of predicted resource usage for each tenant in the correlated tenant pairs. The NNCR 231 then performs validation based on the prediction outcome. Validation includes performing a second layer cross-correlation analysis, which includes performing cross-correlation analysis on the predicted resource usage for each correlated tenant pair to determine incompatible co-tenant pairs. The second layer cross-correlation analysis may be substantially similar to the cross-correlation analysis in the screening process, but may employ the predicted future resource usage from the prediction function instead of the measured past resource usage as employed by the screening function. Pairs with a second layer cross-correlation in excess of a threshold (e.g. τ) are considered an incompatible tenant pair. The NNCR 231 may then provide intelligence to the orchestration system 233 by forwarding the determined incompatible co-tenant pairs toward the orchestration system for hardware resource allocation in the cloud environment 235. It should be noted that τ may be set to ninety five percent (95%) as a default and may be adjusted by a system administrator as desired. Further, τ may be set to different values for the screening function and the validation function if desired. In addition, the NNCR 231 may also be set to send an alert to a system administrator in the event an incompatible co-tenant pair exceeds τ by a predetermined amount and/or in the event the number of determined incompatible co-tenant pairs exceeds a specified number.

The orchestration system 233 may operate in the control plane and be coupled to, or included in, a cloud administration system, such as control plane 110 and cloud administration system 111, respectively. The orchestration system 233 is designed to designate usage of hardware resources in the data plane. Hence, the orchestration system 233 selects which servers operate which tenants. As such, the orchestration system 233 receives the determined incompatible co-tenant pairs from the NNCR 231 and uses the determined incompatible co-tenant pairs to modify the hardware resource allocation in the cloud network by scheduling hardware resource usage such that the incompatible co-tenant pairs do not operate on the same server(s).

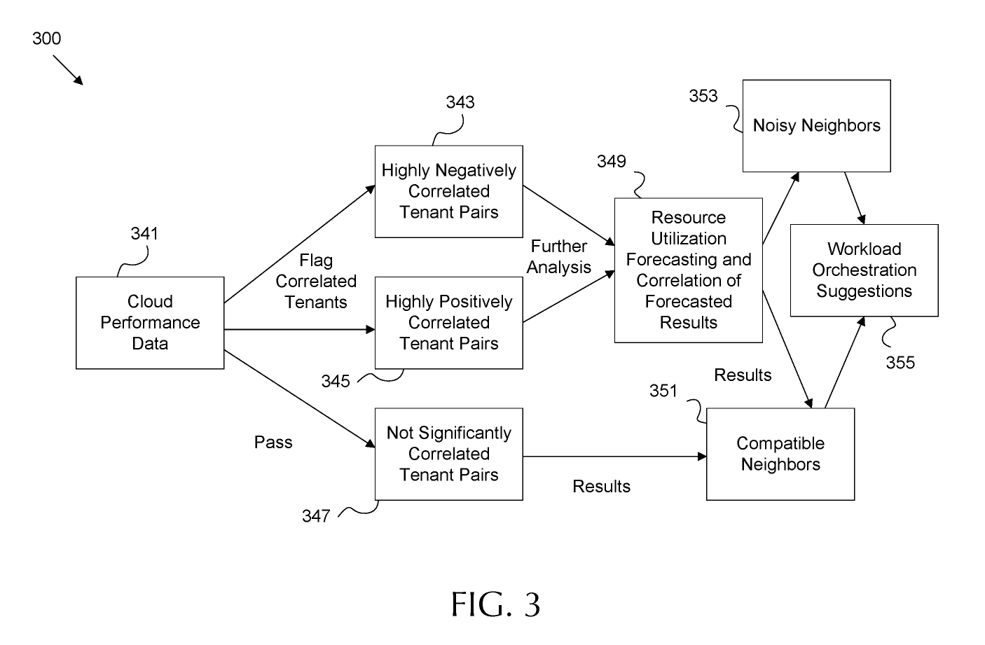

FIG. 3 is a schematic diagram of an example mechanism 300 for identifying noisy neighbor tenants from groups of compatible tenants by a NNCR, such as NNCR 231. Mechanism 300 receives cloud performance data 341 (e.g. from a data collection system 237), which indicates the hardware resource usage of the tenants operating on the servers in a cloud environment. While the cloud performance data is being monitored, cross-correlation analysis is performed on tenant pairs on a server by server basis. Samples of measured past resource usage, of the specified resource to be compared, for each tenant pair are employed as part of the cross-correlation analysis. In mathematical terms, Nₛ may indicate the sample size, while Nₗ may indicate a time lag to be employed as when computing a time series correlation. In some cases Nₗ may be a left shift of Nₛ. The complexity of the cross-correlation may be expressed as:

O(Nₗ×Nₛ) Equation 1

where O indicates mathematical Big O notation that describes the limiting behavior of a function as an tends toward a specified value. The cross-correlation result is compared to a threshold τ to determine whether the tenant pair is correlated. As such, performing cross-correlation analysis generates a cross-correlation coefficient for each time lag. As a result, a number of cross-correlation coefficients are received ranging from −1 to 1. The threshold τ is employed to determine how significant the cross-correlation values are. The threshold τ is a confidence level, essentially a probability to confidently identify the severity of the cross-correlation coefficients. Any cross-correlation value which is within the range of the confidence level set by τ is statistically significant. By applying cross-correlation analysis, each co-tenant pair can be screened into a high negatively correlated tenant pair 343 group if the result is less than −τ, into a highly positively correlated tenant pair 345 group if the result is greater than τ, and a not significantly correlated tenant pair 347 group if the result is less than τ and greater than −τ. The not significantly correlated tenant pairs 347 pass then screen and are determined to be compatible neighbors 351 and are not considered further. The highly negatively correlated tenant pair 343 group and the highly positively correlated tenant pair 345 group are flagged as correlated tenant pairs that are potentially incompatible.

As a specific example, performing cross-correlation analysis may include comparing a time series of resource usage for the tenants in each tenant pair. This may be done by centralizing the time series and taking an average of a product of the time series for the tenant pair to determine a cross-covariance. The cross-covariance may then be normalized to obtain a cross-correlation. The time cross-covariance between a time series of samples of resource usage between two tenants xₜ and yₜ, may be described according to equation 2:

$${σ}_{xy} ( T ) = \frac{1}{N - 1} {\sum }_{t = 1} ( {x}_{t - N} - {μ}_{X} ) ( {y}_{t} - {μ}_{y} ) , \qquad Equation 2$$

where σ_{xy}(T) is the cross-covariance of a corresponding tenant pair including a tenant x and a tenant y, N is a number of resource usage samples in the time series, t is an incremental time variable, x_{t-N} is a resource usage sample of a tenant x at a corresponding time, yₜ is a resource usage sample of a tenant y at a corresponding time, μ_{X} is an average resource usage for tenant x, and μ_{y} is an average resource usage for tenant y. The cross-correlation may then be calculated from the cross-covariance according to equation 3:

$${r}_{xy} ( T ) = \frac{{σ}_{xy}}{\sqrt{{σ}_{xx} ( 0 ) {σ}_{yy} ( 0 )}} , \qquad Equation 3$$

where r_{xy}(T) is the cross-correlation indicating resource usage correlation for a corresponding tenant pair including tenant x and tenant y, σ_{xy} is the cross-covariance of tenant x and tenant y, σₓₓ(0) is a covariance of tenant x, and σ_{yy}(0) is a covariance of tenant y. The resulting cross-correlation then is compared to the confidence level generated at the level τ to either flagged the co-tenant pair as correlated in group 343 or group 345 or pass the co-tenant pair as a not significantly correlated tenant pair 347.

The highly negatively correlated tenant pair group 343 and the highly positively correlated tenant pair group 345, which may be denoted as the subset S, are then considered for further analysis by resource utilization forecasting and correlated of forecasted results 349. The number of tenants in the subset S may be limited by raising τ to increase efficiency of the cloud computing management system. Resource utilization forecasting may include time series forecasting by conducting time series prediction via autoregressive modeling to obtain a corresponding time series of predicted resource usage samples for each tenant in a correlated tenant pair. In other words, desired performance metrics may be employed to generate predicted resource utilization metrics, for example by employing Holt-Winters time series prediction. Cross-correlation analysis may then be conducted on the predicted resource usage for each correlated tenant pair (but only tenants included in S, and not tenants included in not significantly correlated tenants pairs 347). The cross-correlation analysis on the predicted resource usage may be performed in substantially the same manner as cross-correlation analysis of past resource usage, for example by employing equations 2-3. The purpose of the second layer cross-correlation analysis of the flagged tenant pairs is to validate and increase statistical confidence of the identification of noisy neighbors/incompatible co-tenant pairs. Tenant pairs that pass the second layer cross-correlation analysis with a result that lies in the confidence level generated by τ are then considered compatible neighbors 351. Tenant pairs that fails the first cross-correlation analysis the second cross-correlation analysis are considered noisy neighbors 353 that function as incompatible co-tenant pairs. The noisy neighbors 353 and/or the compatible neighbors 351 may then be forwarded as workload orchestration suggestions 355 to an orchestration system, such as orchestration system 233. The orchestration system may make use of the workload orchestration suggestions 355 as intelligence for executing decisions for workload/tenant placement across servers in the cloud. While the present embodiment considers highly negatively correlated tenant pairs 343 to be noisy neighbors/incompatible tenant pairs, it should be noted that alternate embodiments may consider such highly negatively correlated tenant pairs 343 as compatible in some systems. In other words, in such cases negatively correlated tenant pairs are not considered correlated tenant pairs or incompatible co-tenant pairs.

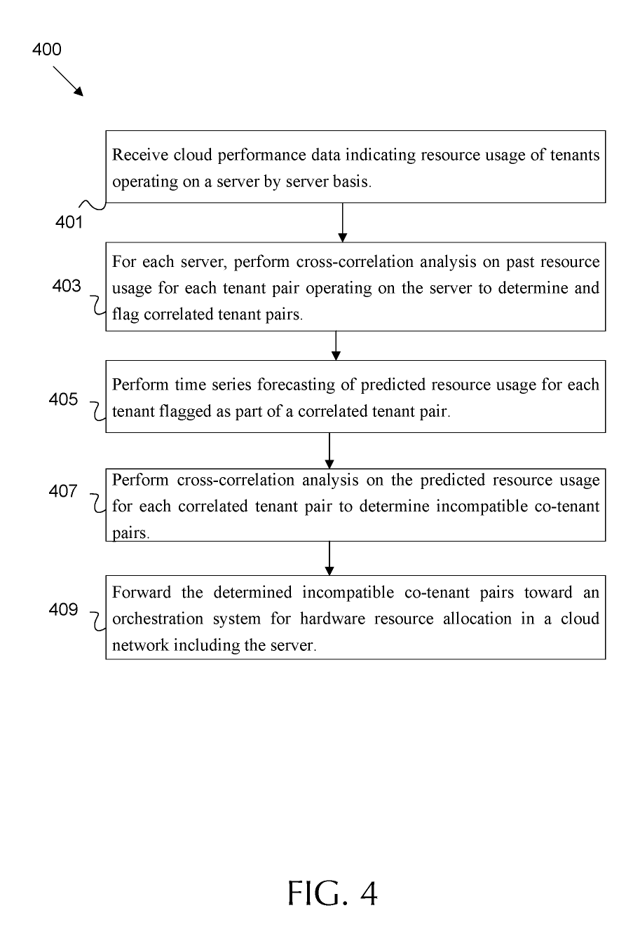

FIG. 4 is a flowchart of an example method 400 for determining neighbor tenants in a cloud network, such as network 100, by employing architecture 200 and mechanism 300. Method 400 may run continuously and/or iteratively on the cloud network. Method 400 may initiate when cloud performance data is received indicating resource usage of tenants operating on each server on a server by server basis at block 401.

At block 403 cross-correlation analysis is performed, for each server, based on past resource usage for each tenant pair operating on the server. The cross-correlation analysis of block 403 may determine and flag correlated tenant pairs. For example, performing cross-correlation analysis may include setting a positive/negative threshold of τ to determine the confidence level to flag correlated tenants. The threshold indicates that tenant pairs with resource usage correlation outside the confidence interval set by the threshold are determined to be positively or negatively correlated tenant pairs, respectively. Cross-correlation analysis may also include comparing a time series of measured resource usage for the tenants in each tenant pair by centralizing the time series and taking an average of a product of the time series for the tenant pair to determine a cross-covariance and normalizing the cross-covariance to obtain a cross-correlation, for example by employing equations 2-3.

At block 405, time series forecasting is performed to determine predicted resource usage for each tenant flagged as part of a correlated tenant pair in block 403. Time series forecasting may include conducting time series prediction via autoregressive modeling to obtain a corresponding time series of predicted resource usage samples.

At block 407, cross-correlation analysis is performed on the expected resource usage for each correlated tenant pair as determined at block 405. The cross-correlation analysis of block 407 (e.g. a second layer cross-correlation analysis) may determine incompatible co-tenant pairs. The cross-correlation analysis of block 407 may be substantially similar to the cross-correlation analysis of block 403, but may only be applied to tenant pairs flagged as correlated tenant pairs in block 407 and may be applied to the predicted resource usage of block 405 instead of measured resource usage.

At block 409, the incompatible co-tenant pairs determined at block 407 are forwarded towards an orchestration system for hardware resource allocation in a cloud network including the server.

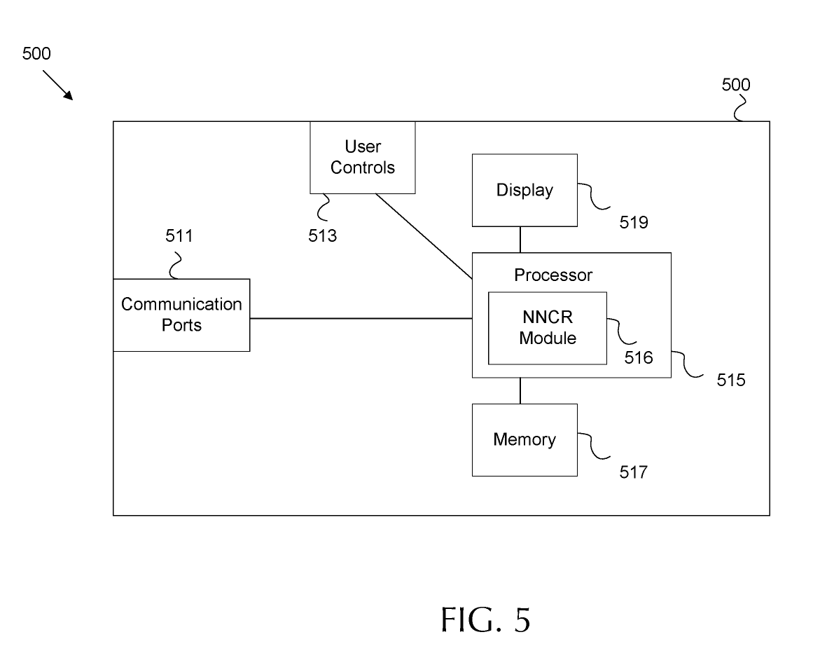

FIG. 5 is a schematic diagram of an example network element 500 for use in a cloud network, such as a cloud administration system 111 in a control plane 110 of a cloud network 100. Network element 500 may be employed to operate a data collection system 237, a noisy neighbor conflict resolution system 231, and/or an orchestration system 233. Further, network element 500 may be configured to implement mechanism 300 and/or method 400.

Network element 500 includes communication ports 511 which may be any electrical and/or optical ports, etc. configured to accept a communication signal for monitoring and/or control purposes, such as receiving cloud performance data and/or communicating incompatible co-tenant pairs. Communication ports 511 may include receivers, transmitters, and/or transceivers. Communications port 511 are coupled to processor 515, which may be implemented as a general purpose processor or other computing circuitry, such as an application specific integrated circuit (ASIC), a digital signal processor (DSP), a field programmable gate array (FPGA), etc. Processor 515 is configured to execute instructions from memory 517 and may perform any methods and/or associated steps indicated by the instructions. Processor 515 may include an NNCR module 516, which may implement a NNCR 231. Accordingly, NNCR module 516 may receive cloud performance data, perform cross-correlation analysis on resource usage to determine correlated tenant pairs, perform time series forecasting, perform cross-correlation analysis on predicted resource usage, and forward incompatible co-tenant pairs use in support of hardware resource allocation. As such, NNCR 516 may perform mechanism 300, method 400, and/or any other method disclosed herein. In some embodiments, NNCR 516 may be implemented in whole or in part in memory 517 as well. Memory 517 may be implemented as processor cache, random access memory (RAM), read only memory (ROM), solid state memory, hard disk drive(s), or any other memory type. Memory 517 acts as a non-transitory medium for storing data, computer program products, and other instructions, and providing such data/products/instruction to the processor 515 for computation as needed.

User controls 513 are coupled to the processor 515. User controls 513 may include a keyboard, mouse, trackball, and/or any other controls employable by a user to interact with NNCR module 516 via a graphical user interface on a display 519. Display 519 may be a digital screen, a cathode ray tube based display, or any other monitor to display results of NNCR module 516 to an end user, for example to support altering τ, and/or reviewing alerts regarding incompatible co-tenant pairs. However, it should be noted that NNCR module 516 may be disaggregated across multiple hardware systems and/or operated on a dedicated machine. As such, user controls 513 and display 519 directly coupled to processor 515 is optional and presented as an exemplary aspect of the disclosed features.

Aspects disclosed herein may operate on a particularly created hardware, on firmware, digital signal processors, or on a specially programmed general purpose computer including a processor operating according to programmed instructions. The term processor as used herein is intended to include microprocessors, microcomputers, Application Specific Integrated Circuits (ASICs), and dedicated hardware controllers. One or more aspects of the invention may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGAs, and the like. Particular data structures may be used to more effectively implement one or more aspects of the invention, and such data structures are contemplated within the scope of computer executable instructions and computer-usable data described herein.

### EXAMPLES

Illustrative examples of the technologies disclosed herein are provided below. An embodiment of the technologies may include any one or more, and any combination of, the examples described below.

Example 1 includes a method for identifying incompatible co-tenant pairs in a cloud network, the method comprising: receiving, at a cloud administration system, cloud performance data indicating resource usage of tenants operating on a server; performing cross-correlation analysis on past resource usage for a plurality of tenant pairs operating on the server to determine one or more correlated tenant pairs; performing time series forecasting of predicted resource usage for the tenants in the correlated tenant pairs; performing cross-correlation analysis on the predicted resource usage for the correlated tenant pairs to determine incompatible co-tenant pairs; and forwarding the determined incompatible co-tenant pairs toward an orchestration system for hardware resource allocation in a cloud network including the server.

Example 2 includes the method of Example 1, in which performing cross-correlation analysis includes setting a threshold indicating a confidence level that tenant pairs with resource usage correlation coefficients outside a confidence interval set by the threshold are determined to be correlated tenant pairs.

Example 3 includes the method of Examples 1-2, in which performing cross-correlation analysis includes comparing a time series of resource usage for the tenants in the tenant pairs.

Example 4 includes the method of Example 3, in which comparing the time series of resource usage for the tenants in the tenant pairs includes centralizing the time series and taking an average of a product of the time series for the tenant pair to determine a cross-covariance.

Example 5 includes the method of Examples 3-4, in which comparing the time series of resource usage for the tenants in the tenant pairs is performed according to:

$${σ}_{xy} ( T ) = \frac{1}{N - 1} {\sum }_{t = 1} ( {x}_{t - N} - {μ}_{X} ) ( {y}_{t} - {μ}_{y} ) ,$$

where σ_{xy}(T) is the cross-covariance of a corresponding tenant pair including a tenant x and a tenant y, N is a number of resource usage samples in the time series, t is an incremental time variable, x_{t-N} is a resource usage sample of a tenant x at a corresponding time, yₜ is a resource usage sample of a tenant y at a corresponding time, μ_{X} is an average resource usage for tenant x, and μ_{y} is an average resource usage for tenant y.

Example 6 includes the method of Examples 3-5, in which comparing the time series of resource usage for the tenants in the tenant pairs includes normalizing the cross-covariance to obtain a cross-correlation.

Example 7 includes the method of Example 6, in which normalizing the cross-covariance is performed according to:

$${r}_{xy} ( T ) = \frac{{σ}_{xy}}{\sqrt{{σ}_{xx} ( 0 ) {σ}_{yy} ( 0 )}} ,$$

where r_{xy}(T) is a cross-correlation coefficient indicating resource usage correlation for a corresponding tenant pair including tenant x and tenant y, σ_{xy} is the cross-covariance of tenant x and tenant y, σₓₓ(0) is a cross-covariance of tenant x, and σ_{yy}(0) is a cross-covariance of tenant y.

Example 8 includes the method of Examples 1-7, in which performing time series forecasting includes conducting time series prediction via autoregressive modeling to obtain a corresponding time series of predicted resource usage samples.

Example 9 includes the method of Examples 1-8, wherein the orchestration system uses the determined incompatible co-tenant pairs to modify the hardware resource allocation in the cloud network including the server.

Example 10 includes the method of Examples 1-9, wherein negatively correlated tenant pairs are not considered correlated tenant pairs or incompatible co-tenant pairs.

Example 11 includes an apparatus for identifying incompatible co-tenant pairs in a cloud network, the apparatus comprising: a communication port to receive cloud performance data indicating resource usage of tenants operating on a server; and circuitry to: perform cross-correlation analysis on past resource usage for a plurality of tenant pairs operating on the server to determine one or more correlated tenant pairs; perform time series forecasting of predicted resource usage for the tenants in the correlated tenant pairs; perform cross-correlation analysis on the predicted resource usage for the correlated tenant pairs to determine incompatible co-tenant pairs; and forward the determined incompatible co-tenant pairs toward an orchestration system for hardware resource allocation in a cloud network including the server.

Example 12 includes the apparatus of Example 11, in which performing cross-correlation analysis includes setting a threshold indicating a confidence level that tenant pairs with resource usage correlation coefficients outside a confidence interval set by the threshold are determined to be correlated tenant pairs.

Example 13 includes the apparatus of Examples 11-12, in which performing cross-correlation analysis includes comparing a time series of resource usage for the tenants in the tenant pairs.

Example 14 includes the apparatus of Example 13, in which comparing the time series of resource usage for the tenants in the tenant pairs includes centralizing the time series and taking an average of a product of the time series for the tenant pair to determine a cross-covariance.

Example 15 includes the apparatus of Examples 13-14, in which comparing the time series of resource usage for the tenants in the tenant pairs is performed according to:

$${σ}_{xy} ( T ) = \frac{1}{N - 1} {\sum }_{t = 1} ( {x}_{t - N} - {μ}_{X} ) ( {y}_{t} - {μ}_{y} ) ,$$

where σ_{xy}(T) is the cross-covariance of a corresponding tenant pair including a tenant x and a tenant y, N is a number of resource usage samples in the time series, t is an incremental time variable, x_{t-N} is a resource usage sample of a tenant x at a corresponding time, yₜ is a resource usage sample of a tenant y at a corresponding time, μ_{X} is an average resource usage for tenant x, and μ_{y} is an average resource usage for tenant y.

Example 16 includes the apparatus of Examples 13-15, in which comparing the time series of resource usage for the tenants in the tenant pairs includes normalizing the cross-covariance to obtain a cross-correlation.

Example 17 includes the apparatus of Example 16, in which normalizing the cross-covariance is performed according to:

$${r}_{xy} ( T ) = \frac{{σ}_{xy}}{\sqrt{{σ}_{xx} ( 0 ) {σ}_{yy} ( 0 )}} ,$$

where r_{xy}(T) is a cross-correlation coefficient indicating resource usage correlation for a corresponding tenant pair including tenant x and tenant y, σ_{xy} is the cross-covariance of tenant x and tenant y, σₓₓ(0) is a cross-covariance of tenant x, and σ_{yy}(0) is a cross-covariance of tenant y.

Example 18 includes the apparatus of Examples 11-17, in which performing time series forecasting includes conducting time series prediction via autoregressive modeling to obtain a corresponding time series of predicted resource usage samples.

Example 19 includes the apparatus of Examples 11-18, wherein the orchestration system uses the determined incompatible co-tenant pairs to modify the hardware resource allocation in the cloud network including the server.

Example 20 includes the apparatus of Examples 11-19, wherein negatively correlated tenant pairs are not considered correlated tenant pairs or incompatible co-tenant pairs.

Example 21 includes a non-transitory computer readable medium for storing a computer program product comprising instructions for identifying incompatible co-tenant pairs in a cloud network, the instructions, when executed by a processor of a cloud computing administration apparatus, causing the cloud computing administration apparatus to: receive cloud performance data indicating resource usage of tenants operating on a server; perform cross-correlation analysis on past resource usage for a plurality of tenant pairs operating on the server to determine one or more correlated tenant pairs; perform time series forecasting of predicted resource usage for the tenants in the correlated tenant pairs; perform cross-correlation analysis on the predicted resource usage for the correlated tenant pairs to determine incompatible co-tenant pairs; and forward the determined incompatible co-tenant pairs toward an orchestration system for hardware resource allocation in a cloud network including the server.

Example 22 includes the non-transitory computer readable medium of Example 21, in which performing cross-correlation analysis includes setting a threshold indicating a confidence level that tenant pairs with resource usage correlation coefficients outside a confidence interval set by the threshold are determined to be correlated tenant pairs.

Example 23 includes the non-transitory computer readable medium of Examples 21-22, in which performing cross-correlation analysis includes comparing a time series of resource usage for the tenants in the tenant pairs.

Example 24 includes the non-transitory computer readable medium of Example 23, in which comparing the time series of resource usage for the tenants in the tenant pairs includes centralizing the time series and taking an average of a product of the time series for the tenant pair to determine a cross-covariance.

Example 25 includes the non-transitory computer readable medium of Examples 23-24, in which comparing the time series of resource usage for the tenants in the tenant pairs is performed according to:

$${σ}_{xy} ( T ) = \frac{1}{N - 1} {\sum }_{t = 1} ( {x}_{t - N} - {μ}_{X} ) ( {y}_{t} - {μ}_{y} ) ,$$

where σ_{xy}(T) is the cross-covariance of a corresponding tenant pair including a tenant x and a tenant y, N is a number of resource usage samples in the time series, t is an incremental time variable, x_{t-N} is a resource usage sample of a tenant x at a corresponding time, yₜ is a resource usage sample of a tenant y at a corresponding time, μ_{X} is an average resource usage for tenant x, and μ_{y} is an average resource usage for tenant y.

Example 26 includes the non-transitory computer readable medium of Examples 23-25, in which comparing the time series of resource usage for the tenants in the tenant pairs includes normalizing the cross-covariance to obtain a cross-correlation.

Example 27 includes the non-transitory computer readable medium of Example 26, in which normalizing the cross-covariance is performed according to:

$${r}_{xy} ( T ) = \frac{{σ}_{xy}}{\sqrt{{σ}_{xx} ( 0 ) {σ}_{yy} ( 0 )}} ,$$

where r_{xy}(T) is a cross-correlation coefficient indicating resource usage correlation for a corresponding tenant pair including tenant x and tenant y, σ_{xy} is the cross-covariance of tenant x and tenant y, σₓₓ(0) is a cross-covariance of tenant x, and σ_{yy}(0) is a cross-covariance of tenant y.

Example 28 includes the non-transitory computer readable medium of Examples 21-27, in which performing time series forecasting includes conducting time series prediction via autoregressive modeling to obtain a corresponding time series of predicted resource usage samples.

Example 29 includes the apparatus of Examples 21-28, wherein the orchestration system uses the determined incompatible co-tenant pairs to modify the hardware resource allocation in the cloud network including the server.

Example 30 includes the apparatus of Examples 21-29, wherein negatively correlated tenant pairs are not considered correlated tenant pairs or incompatible co-tenant pairs.

Example 31 includes an apparatus for identifying incompatible co-tenant pairs in a cloud network, the apparatus comprising: means for receiving cloud performance data indicating resource usage of tenants operating on a server; means for performing cross-correlation analysis on past resource usage for a plurality of tenant pairs operating on the server to determine one or more correlated tenant pairs; means for performing time series forecasting of predicted resource usage for the tenants in the correlated tenant pairs; means for performing cross-correlation analysis on the predicted resource usage for the correlated tenant pairs to determine incompatible co-tenant pairs; and means for forwarding the determined incompatible co-tenant pairs toward an orchestration system, via the communication means, for hardware resource allocation in a cloud network including the server.

Example 32 includes the apparatus of Example 31, in which performing cross-correlation analysis includes setting a threshold indicating a confidence level that tenant pairs with resource usage correlation coefficients outside a confidence interval set by the threshold are determined to be correlated tenant pairs.

Example 33 includes the apparatus of Examples 31-32, in which performing cross-correlation analysis includes comparing a time series of resource usage for the tenants in the tenant pairs.

Example 34 includes the apparatus of Example 33, in which comparing the time series of resource usage for the tenants in the tenant pairs includes centralizing the time series and taking an average of a product of the time series for the tenant pair to determine a cross-covariance.

Example 35 includes the apparatus of Examples 33-34, in which comparing the time series of resource usage for the tenants in the tenant pairs is performed according to:

$${σ}_{xy} ( T ) = \frac{1}{N - 1} {\sum }_{t = 1} ( {x}_{t - N} - {μ}_{X} ) ( {y}_{t} - {μ}_{y} ) ,$$

where σ_{xy}(T) is the cross-covariance of a corresponding tenant pair including a tenant x and a tenant y, N is a number of resource usage samples in the time series, t is an incremental time variable, x_{t-N} is a resource usage sample of a tenant x at a corresponding time, yₜ is a resource usage sample of a tenant y at a corresponding time, μ_{X} is an average resource usage for tenant x, and μ_{y} is an average resource usage for tenant y.

Example 36 includes the apparatus of Examples 33-35, in which, in which comparing the time series of resource usage for the tenants in the tenant pairs includes normalizing the cross-covariance to obtain a cross-correlation.

Example 372 includes the apparatus of Example 36, in which normalizing the cross-covariance is performed according to:

$${r}_{xy} ( T ) = \frac{{σ}_{xy}}{\sqrt{{σ}_{xx} ( 0 ) {σ}_{yy} ( 0 )}} ,$$

where r_{xy}(T) is a cross-correlation coefficient indicating resource usage correlation for a corresponding tenant pair including tenant x and tenant y, σ_{xy} is the cross-covariance of tenant x and tenant y, σₓₓ(0) is a cross-covariance of tenant x, and σ_{yy}(0) is a cross-covariance of tenant y.

Example 38 includes the apparatus of Examples 31-37, in which performing time series forecasting includes conducting time series prediction via autoregressive modeling to obtain a corresponding time series of predicted resource usage samples.

Example 39 includes the apparatus of Examples 31-38, wherein the orchestration system uses the determined incompatible co-tenant pairs to modify the hardware resource allocation in the cloud network including the server.

Example 40 includes the apparatus of Examples 31-39, wherein negatively correlated tenant pairs are not considered correlated tenant pairs or incompatible co-tenant pairs.

The previously described versions of the disclosed subject matter have many advantages that were either described or would be apparent to a person of ordinary skill. Even so, all of these advantages or features are not required in all versions of the disclosed apparatus, systems, or methods.

Additionally, this written description makes reference to particular features. It is to be understood that the disclosure in this specification includes all possible combinations of those particular features. For example, where a particular feature is disclosed in the context of a particular aspect or embodiment, that feature can also be used, to the extent possible, in the context of other aspects and embodiments.

Also, when reference is made in this application to a method having two or more defined steps or operations, the defined steps or operations can be carried out in any order or simultaneously, unless the context excludes those possibilities.

Although specific embodiments of the invention have been illustrated and described for purposes of illustration, it will be understood that various modifications may be made without departing from the spirit and scope of the invention. Accordingly, the invention should not be limited except as by the appended claims.

We claim:

1. A method comprising:
receiving, at a cloud administration system, cloud performance data indicating resource usage of tenants operating on a server;
performing cross-correlation analysis on past resource usage for a plurality of tenant pairs operating on the server to determine one or more correlated tenant pairs;
performing time series forecasting of predicted resource usage for the tenants in the correlated tenant pairs;
performing cross-correlation analysis on the predicted resource usage for the correlated tenant pairs to determine incompatible co-tenant pairs; and
forwarding the determined incompatible co-tenant pairs toward an orchestration system for hardware resource allocation in a cloud network including the server.

2. The method of claim 1, in which performing cross-correlation analysis includes setting a threshold indicating a confidence level that tenant pairs with resource usage correlation coefficients outside a confidence interval set by the threshold are determined to be correlated tenant pairs.

3. The method of claim 1, in which performing cross-correlation analysis includes comparing a time series of resource usage for the tenants in the tenant pairs.

4. The method of claim 3, in which comparing the time series of resource usage for the tenants in the tenant pairs includes centralizing the time series and taking an average of a product of the time series for the tenant pair to determine a cross-covariance.

5. The method of claim 4, in which comparing the time series of resource usage for the tenants in the tenant pairs is performed according to:
$${σ}_{xy} ( T ) = \frac{1}{N - 1} {\sum }_{t = 1} ( {x}_{t - N} - {μ}_{X} ) ( {y}_{t} - {μ}_{y} ) ,$$
where σ_{xy}(T) is the cross-covariance of a corresponding tenant pair including a tenant x and a tenant y, N is a number of resource usage samples in the time series, t is an incremental time variable, x_{t-N} is a resource usage sample of a tenant x at a corresponding time, yₜ is a resource usage sample of a tenant y at a corresponding time, μ_{X} is an average resource usage for tenant x, and μ_{y} is an average resource usage for tenant y.

6. The method of claim 4, in which comparing the time series of resource usage for the tenants in the tenant pairs includes normalizing the cross-covariance to obtain a cross-correlation.

7. The method of claim 6, in which normalizing the cross-covariance is performed according to:
$${r}_{xy} ( T ) = \frac{{σ}_{xy}}{\sqrt{{σ}_{xx} ( 0 ) {σ}_{yy} ( 0 )}} ,$$
where r_{xy}(T) is a cross-correlation coefficient indicating resource usage correlation for a corresponding tenant pair including tenant x and tenant y, σ_{xy} is the cross-covariance of tenant x and tenant y, σₓₓ(0) is a cross-covariance of tenant x, and σ_{yy}(0) is a cross-covariance of tenant y.

8. The method of claim 1, wherein the orchestration system uses the determined incompatible co-tenant pairs to modify the hardware resource allocation in the cloud network including the server.

9. The method of claim 1, wherein negatively correlated tenant pairs are not considered correlated tenant pairs or incompatible co-tenant pairs.

10. An apparatus comprising:
a communication port to receive cloud performance data indicating resource usage of tenants operating on a server; and
circuitry to:
perform cross-correlation analysis on past resource usage for a plurality of tenant pairs operating on the server to determine one or more correlated tenant pairs;
perform time series forecasting of predicted resource usage for the tenants in the correlated tenant pairs;
perform cross-correlation analysis on the predicted resource usage for the correlated tenant pairs to determine incompatible co-tenant pairs; and
forward the determined incompatible co-tenant pairs toward an orchestration system for hardware resource allocation in a cloud network including the server.

11. The apparatus of claim 9, in which performing cross-correlation analysis includes setting a threshold indicating a confidence level that tenant pairs with resource usage correlation coefficients outside a confidence interval set by the threshold are determined to be correlated tenant pairs.

12. The apparatus of claim 11, in which performing cross-correlation analysis includes comparing a time series of resource usage for the tenants in the tenant pairs by centralizing the time series and taking an average of a product of the time series for the tenant pair to determine a cross-covariance.

13. The apparatus of claim 12, in which comparing the time series of resource usage for the tenants in the tenant pairs includes normalizing the cross-covariance to obtain a cross-correlation.

14. The apparatus of claim 9, in which performing time series forecasting includes conducting time series prediction via autoregressive modeling to obtain a corresponding time series of predicted resource usage samples.

15. A non-transitory computer readable medium for storing a computer program product comprising instructions for identifying incompatible co-tenant pairs in a cloud network, the instructions, when executed by a processor of a cloud computing administration apparatus, causing the cloud computing administration apparatus to:
receive cloud performance data indicating resource usage of tenants operating on a server;
perform cross-correlation analysis on past resource usage for a plurality of tenant pairs operating on the server to determine one or more correlated tenant pairs;
perform time series forecasting of predicted resource usage for the tenants in the correlated tenant pairs;
perform cross-correlation analysis on the predicted resource usage for the correlated tenant pairs to determine incompatible co-tenant pairs; and
forward the determined incompatible co-tenant pairs toward an orchestration system for hardware resource allocation in a cloud network including the server.

16. The non-transitory computer readable medium of claim 15, in which performing cross-correlation analysis includes setting a threshold indicating a confidence level that tenant pairs with resource usage correlation coefficients outside a confidence interval set by the threshold are determined to be correlated tenant pairs.

17. The non-transitory computer readable medium of claim 15, in which performing cross-correlation analysis includes comparing a time series of resource usage for the tenants in the tenant pairs.

18. The non-transitory computer readable medium of claim 17, in which comparing the time series of resource usage for the tenants in the tenant pairs includes centralizing the time series and taking an average of a product of the time series for the tenant pair to determine a cross-covariance.

19. The non-transitory computer readable medium of claim 18, in which comparing the time series of resource usage for the tenants in the tenant pairs includes normalizing the cross-covariance to obtain a cross-correlation.

20. The non-transitory computer readable medium of claim 15, in which performing time series forecasting includes conducting time series prediction via autoregressive modeling to obtain a corresponding time series of predicted resource usage samples.

21. An apparatus comprising:
means for receiving cloud performance data indicating resource usage of tenants operating on a server;
means for performing cross-correlation analysis on past resource usage for a plurality of tenant pairs operating on the server to determine one or more correlated tenant pairs;
means for performing time series forecasting of predicted resource usage for the tenants in the correlated tenant pairs;
means for performing cross-correlation analysis on the predicted resource usage for the correlated tenant pairs to determine incompatible co-tenant pairs; and
means for forwarding the determined incompatible co-tenant pairs toward an orchestration system, via the communication means, for hardware resource allocation in a cloud network including the server.

22. The apparatus of claim 21, in which performing cross-correlation analysis includes setting a threshold indicating a confidence level that tenant pairs with resource usage correlation coefficients outside a confidence interval set by the threshold are determined to be correlated tenant pairs.

23. The apparatus of claim 21, in which performing cross-correlation analysis includes comparing a time series of resource usage for the tenants in the tenant pairs.

24. The apparatus of claim 23, in which comparing the time series of resource usage for the tenants in the tenant pairs includes centralizing the time series and taking an average of a product of the time series for the tenant pair to determine a cross-covariance.

25. The apparatus of claim 24, in which, in which comparing the time series of resource usage for the tenants in the tenant pairs includes normalizing the cross-covariance to obtain a cross-correlation.
